(19) United States
(12) Patent Application Publication
(10) Pub. No.: US 2011/0201306 A1
(43) Pub. Date: Aug. 18, 2011

(54) SYSTEMS AND METHODS FOR UNIFIED BILLING

(75) Inventor: MANSOUR ALI AL-HARBI, Riyadh (SA)

(73) Assignee: Samama Technologies, Riyadh (SA)

(21) Appl. No.: 12/705,661

(22) Filed: Feb. 15, 2010

(51) Int. Cl. H04M 1/66; G06F 21/00; G06Q 20/00; G06Q 40/00; G06Q 30/00

(52) U.S. Cl. 455/411; 726/28; 705/44; 705/38; 705/34; 705/40; 455/558

(57) ABSTRACT

A system for unified billing combining mobile telephone and credit card services, in one example embodiment comprises a communication module to receive, from a merchant, a request to process a transaction, the request including data related to a subscriber identity module (SIM), a customer identification module to identify, based on the data, a customer associated with the subscriber identity module (SIM), a credit verification module to ascertain information related to a credit account associated with the customer, a code generating module to selectively generate a security code to be sent to the subscriber identity module (SIM), the security code to be provided to the merchant in order to complete the transaction, a code verification module to receive and verify the security code sent by the merchant, and a transaction module to selectively complete the transaction based on the security code verification.

### FIELD

This application relates generally to data processing and more specifically to computer-implemented systems and methods for unified billing.

### BACKGROUND

Mobile phones have been steadily evolving as all-purpose devices offering advanced capabilities previously limited to general-purpose computers. Mobile payment is a rapidly evolving alternative payment method. Instead of paying with cash, check, or credit cards, a consumer can use his mobile phone to pay for a wide range of services and digital or hard goods. For example, a consumer can use a special mobile phone equipped with a smartcard, which can be waved within a detectable range of a reader module to buy groceries. The payment can be deducted from a bank account or charged to a credit card associated with the customer's mobile phone account. Alternatively, the payment can be billed as part of the periodic phone bill.

However, because each mobile operator (Telephone Company) acts independently to deploy its mobile payment service, these payment systems are limited to their specific operators and subject to the customer's willingness to switch from one mobile operator to another. The switching, besides being an inconvenience, can result in additional and overlapping charges. Moreover, a large deployment of the operator-centric model can be severely challenged by the lack of connection to existing payment networks. Likewise, the direct operator billing lacks portability because it requires integration with a specific operator billing system.

### BRIEF DESCRIPTION OF DRAWINGS

Example embodiments are illustrated by way of examples and not limitations in the figures of the accompanying drawings, in which like references indicate similar elements, and in which:

FIG. 1 is a block diagram showing a network environment within which systems and methods for unified billing are implemented, in accordance with an example embodiment;

FIG. 2 is a block diagram showing a unified billing system, in accordance with an example embodiment;

FIG. 3 is a flow chart showing a method for unified billing, in accordance with an example embodiment;

FIG. 4 is a block diagram showing an online merchant environment utilizing a unified billing system in accordance with an example embodiment;

FIG. 5 is a block diagram showing a brick and mortar merchant environment utilizing a unified billing system, in accordance with an example embodiment;

FIG. 6 is a block diagram showing a brick and mortar merchant environment with an authorized user utilizing a unified billing system, in accordance with an example embodiment;

FIG. 7 is a block diagram showing a unified bill, in accordance with an example embodiment; and

FIG. 8 is a diagrammatic representation of an example machine in the form of a computer system within which a set of instructions for causing the machine to perform any one or more of the methodologies discussed herein is executed.

### DETAILED DESCRIPTION

Example systems and methods for unified billing are described. In the following description, for purposes of explanation, numerous specific details are set forth in order to provide a thorough understanding of example embodiments. It will be evident, however, to one skilled in the art, that the present invention may be practiced without these specific details.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, and other embodiments can be formed by introducing structural, logical or electrical changes without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The instant disclosure is related to systems and methods for unified billing. Systems and methods for unified billing combine functionalities of a mobile telephone and a credit card and allow processing of mobile payments in the environment independent of the established mobile operator payment systems. A customer willing to enroll in the service which is provided by the unified billing system may apply for a credit account. Once the request for the credit account is approved, the customer's mobile telephone can be utilized to pay for wide range of services and digital or hard goods as well as to pay for the mobile operator service. To provide the customer with additional security, the telephone number and the mobile device itself can be utilized as a two-factor authentication system. Because the unified billing system is not operator-specific, a customer cannot incur additional or overlapping charges in the process of switching from one operator to another.

In one example embodiment, upon initiation of a payment to a merchant participating in the unified billing system, a customer can receive a Short Message Service (SMS) message. The SMS can include the amount being charged and a security code to be provided to the merchant. Upon receiving the security code, the merchant can complete the transaction. In the end of the billing period instead of receiving multiple bills for different purchases, the customer will receive one bill listing the purchases made by the customer and other authorized persons. Each merchant can be paid when the customer settles his account with the unified billing system provider. Thus, the unified billing system provider can facilitate mobile payments by combining mobile and credit card services. The unified billing system provider can collect a fee from each merchant utilizing the service such as, for example, a restaurant, a mobile operator, and a supermarket.

As mentioned above, one of the problems with a traditional mobile service operator is the inconvenience in switching from one operator to another operator. Additionally, there is an inherent conflict of interest between collecting payments due to third party merchants and, at the same time, providing the customer with basic telephone service. Furthermore, a merchant participating in a traditional operator billing system is typically charged a high transaction fee (sometimes as high as 50%) by the operator for providing the bill collecting services. In case the bill is not paid, the operator has the ability to block customer's account and may even blacklist the customer, making it difficult for the customer to get service elsewhere.

Moreover, there are security considerations as employees of the mobile operator can easily engage in unauthorized viewing of the customer's records. Other issues with the traditional bill payment systems include the ability of credit card providers to increase a customer's interest rate without his consent as well as to charge fees related to late payments.

In contrast to the traditional mobile service and credit card operators being separate entities, systems and methods for unified billing facilitate implementation of a combined entity, which can provide both credit and mobile services. Using this combined service, a customer can, for example, pay for parking, groceries, order food from a restaurant, and order a book online using his mobile device. Additionally the customer can enable other authorized users (e.g., family members) to shop and pay for goods and services using the unified billing system.

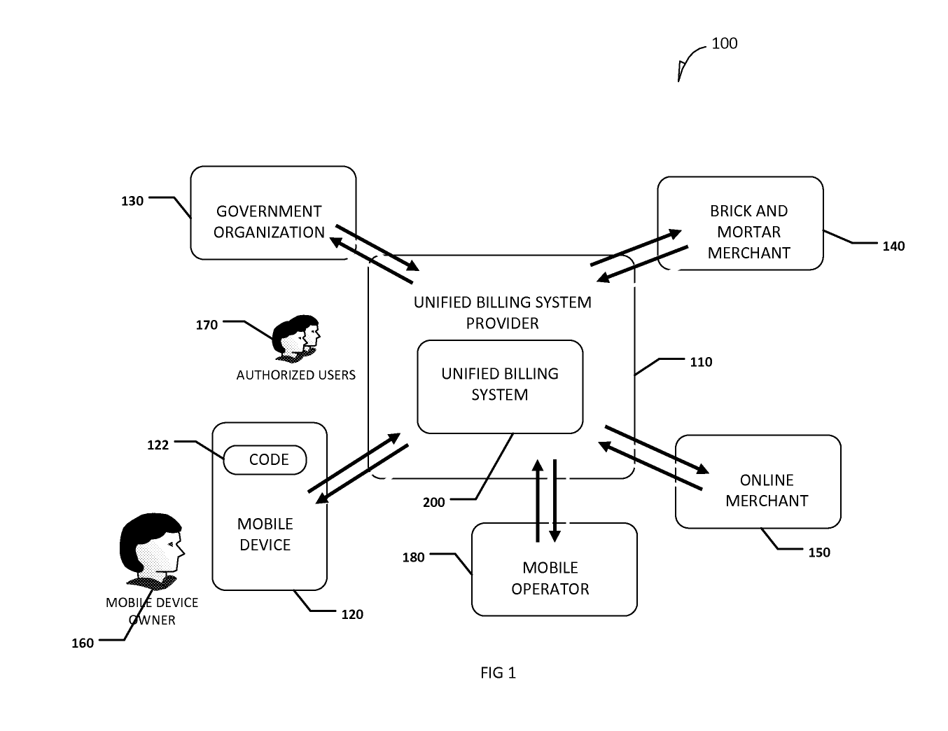

FIG. 1 is a block diagram showing a network environment 100 within which systems and methods for unified billing can be implemented, in accordance with an example embodiment. As shown in FIG. 1, the example network environment 100 can include a unified billing system provider 110, which in turn can include a unified billing system 200. The network environment 100 can further include a government organization 130, a brick and mortar store 140, an online merchant 150, a mobile device owner 160, authorized users 170 and a mobile operator 180. The mobile owner 160 can own a mobile device 120, which can be used to receive and display an authorization code 122 to facilitate secure mobile purchases.

The government organization 130 can be a government agency that, for example, collects taxes from the mobile device owner 160. The mobile device owner 160 can utilize unified billing system 200 to pay the taxes. The brick and mortar merchant 140 can be a company with physical buildings such as a grocery store or a restaurant whereas the online merchant 150 may have no physical presence.

The mobile device 120 (also known as mobile phone, handheld device, handheld computer, “Palmtop” or simply handheld) is a pocket-sized computing device, typically having a display screen with touch input or a miniature keyboard. In the case of the personal digital assistant (PDA) the input and output are combined into a touch-screen interface. Smart phones and PDAs can also be popular amongst those who require the assistance and convenience of a conventional computer, in environments where carrying one would not be practical. The mobile device 120 can include integrated data capture devices like barcode, RFID and smart card readers.

As mentioned above, the unified billing system 200 can permit combining mobile telephone and credit card services. Thus, instead of requesting a mobile operator to issue a Subscriber Identity Module (SIM), a customer can request the unified billing system provider 200 to issue the SIM and a mobile number plus a credit card that can be used for various payments.

Nowadays, customers can often use their telephones as payment gateways. Some providers that allow customers to use their telephones as payment gateways as a payment method charge up to 50% of the amount of the purchase to the merchant. There can be two types of payment either by connecting one's mobile phone to one's r credit card or by having the provider bill the customer for the total amount of all purchases at the end of the month. For example, in the provider billing situation, if a customer wants to buy food for $15, at the end of the month he will get a bill for $15 and have to pay the bill directly to the provider. The provider will charge the merchant 50% of the amount.

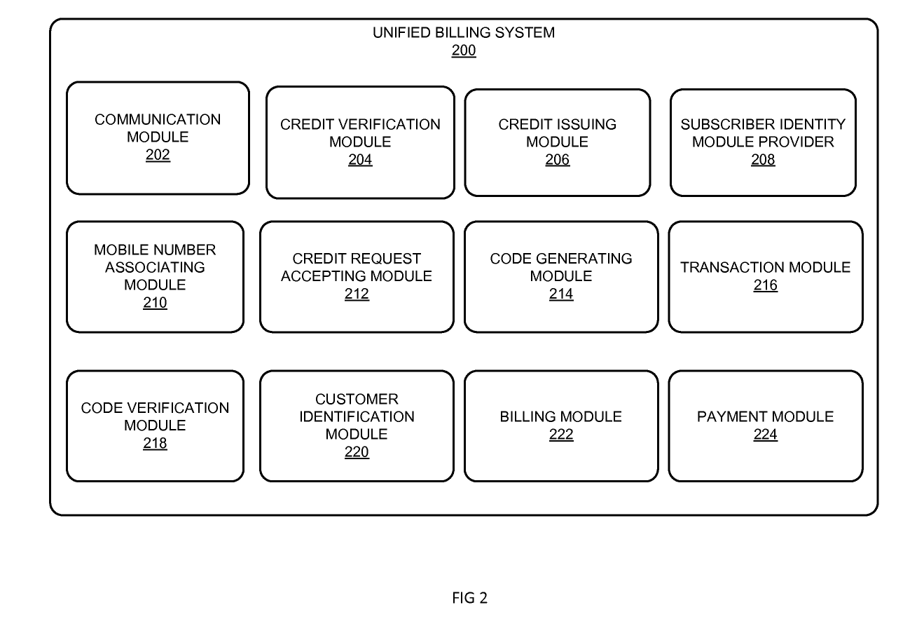

Another example is where one's mobile number is connected to one's credit card. When such person goes to a supermarket and would like to pay using his mobile phone, the merchant will not provide goods or services pending the payment by the telephone operator but instead charge one's credit card. Therefore, there will be no additional charges on the phone bill, the amount of the purchase will be charged to the credit card. Therefore, there are two ways of mobile payments, first putting the purchase amount on a phone bill, the second putting the purchase amount on the credit card. The unified billing system 200 is discussed in more detail below with reference to FIG. 2.

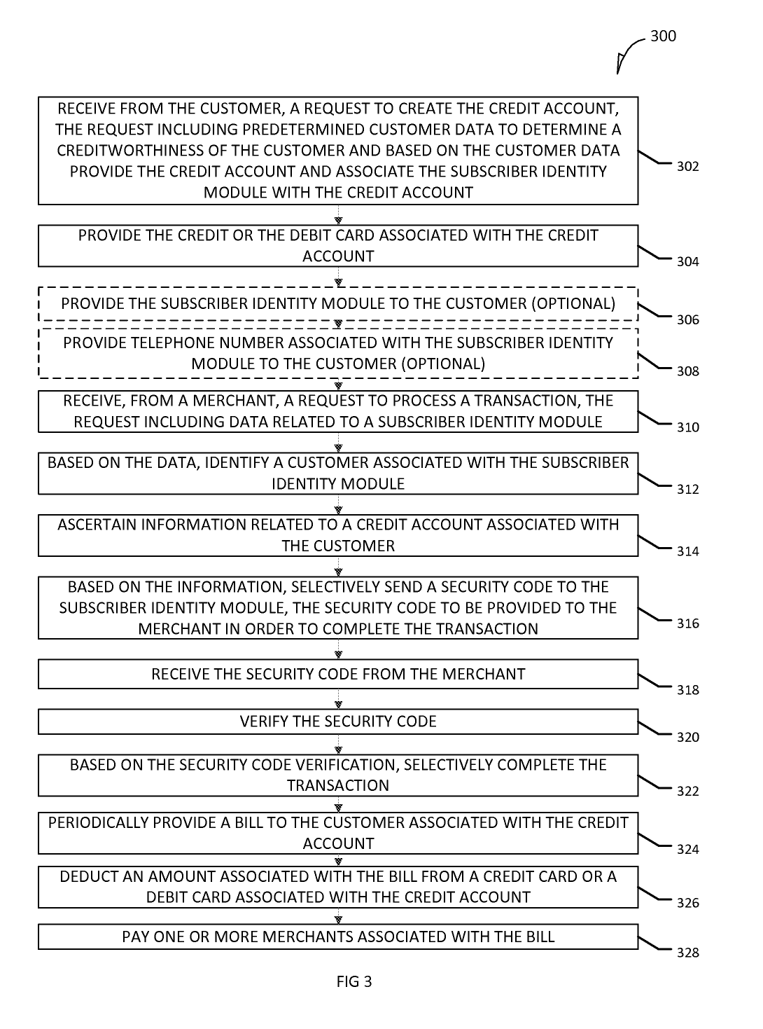

FIG. 2 is a block diagram showing the unified billing system 200. In some example embodiments, the unified billing system 200 can include a communication module 202, a credit verification module 204, a credit issuing module 206, a subscriber identity module (SIM) provider 208, a mobile number associating module 210, a credit request accepting module 212, a code generating module 214, a transaction module 216, a code verification module 218, a customer identification module 220, a billing module 222, and a payment module 224. Example operations of these modules are described below with reference to FIG. 3.

FIG. 3 is a flow chart showing a method for unified billing 300, in accordance with an example embodiment. The method 300 may be performed by processing logic that may comprise hardware (e.g., dedicated logic, programmable logic, microcode, etc.), software (such as that which is run on a general-purpose computer system or a dedicated machine), or a combination of both. In one example embodiment, the processing logic resides within the unified billing system 200 illustrated in FIG. 2.

Traditional mobile billing can operate by first connecting a mobile phone to an operator (Telephone Company). For example, a mobile phone can be connected to a user's mobile operator such as Sprint, wherein Sprint has a billing department mechanism which is in turn connected to the user's bank account or credit card. Therefore, any purchase using a mobile phone, will cause the charge to be deducted from the buyer's bank account or credit card. Under a traditional method, a cashier can scan the screen of a mobile device and a request will be sent to the purchaser's bank account, and then the amount will be deducted therefrom. If, however, there is not enough money in the bank account, the buyer and seller will not be able to process the transaction.

In contrast, the unified billing system 200 can provide its consumers with a way of not having to instruct the merchant to access the consumer's bank account directly. Instead, unified billing system 200 offers a scheme for utilizing a new kind of company that acts in a credit-providing capacity. Thereby, the transaction will be credited instead of being debited. This means that at the end of the month, the user will have all of his purchases on one phone bill that he can pay later. The charges do not go onto the user's credit card but rather onto his phone bill.

Presently, each operator, such as Sprint, AT&T, T-mobile, and Verizon have a unique internal billing system. These billing systems allow the operators to charge the customers individually. All of these billing systems are different. In contrast, the unified billing system allows outsourcing the billing services from these providers to a third party. This includes mobile operator services and other goods and services, for example restaurants, hotels, and supermarkets. For example, a customer can call a restaurant and order a meal. The customer provides the restaurant his mobile number. The restaurant can send an electronic request to the unified billing provider 110. The unified billing system 200 can process the request and send the customer an SMS with a six-digit code, which the customer provides to the restaurant. The restaurant can send the six-digit code to the unified billing provider for verification. Once the six-digit code is verified, the order is complete and the meal is provided to the customer.

In some example embodiments, a method for unified billing 300 may commence at operation 302 with the communication module 202 of the unified billing system 200 receiving from the mobile device owner 160 a request to create the credit account. The request can include accompanying mobile device owner 160 data to determine the creditworthiness of the mobile device owner 160, Upon receiving the request from the mobile device owner 160, the credit verification module 204 can perform determine the creditworthiness of the mobile device owner 160 based on the mobile device owner 160. If the mobile device owner 160 is considered creditworthy, the unified billing system 200 can provide the mobile device owner 160 with a credit account and associate the subscriber identity module (SIM) of the mobile device owner 160 with the credit account.

If the credit account is issued, at operation 304, the credit issuing module 206 can provide the credit or the debit card associated with the credit account. In some example embodiments, the mobile device owner 160 does not own a SIM and may wish that the unified billing system issues a SIM to him. Thus, as an option, at operation 306, the subscriber identity module (SIM) provider 208 can provide the subscriber identity module (SIM) to the customer. Likewise, the mobile device owner 160 may wish to acquire a new telephone number from the unified billing system provider 110. Thus, optionally, at operation 308, the mobile number association module 210 can provide a telephone number associated with the subscriber identity module (SIM) to the customer.

Once the credit account is established, the mobile device owner 160 or the authorized users 170 can utilize the mobile device 120 to make payments wherever such payments are accepted. When a payment is initiated, the communication module 202 of the unified billing system 200 can receive from a merchant, at operation 310 a request to process a transaction. The request can include data identifying the subscriber identity module (SIM) of the mobile device 120. Based on this data, at operation 312, the customer identification module 220 can identify the mobile device owner 160 associated with the subscriber identity module (SIM).

At operation 314, the credit verification module 204 can verify that the credit account is associated with the mobile device owner and that the restrictions associated with the credit account permit the payment to be processed. If the verification is successful, at operation 316, the code generating module 214 can selectively send the code 122 to the subscriber identity module (SIM) of the mobile device 120. The mobile device owner 160 of the authorized users 170 can provide the code 122 to the merchant in order to complete the transaction. The merchant can send the code 122 to the unified billing system 200 for verification. Thus, at operation 318, the code verification module 218 can receive the code 122 from the merchant and at operation 320, the code verification module 218 can verify the code 122.

If the code verification is successful, at operation 322, the transaction module 216 can complete the transaction. At operation 324, the billing module 222 can periodically provide a bill to the mobile device owner 160. At operation 326, the billing module 222 can deduct the amount associated with the bill from a credit card or a debit card associated with the credit account. Once the mobile device owner 160 makes the payment, at operation 328, the payment module 224 can pay one or more merchants associated with the bill.

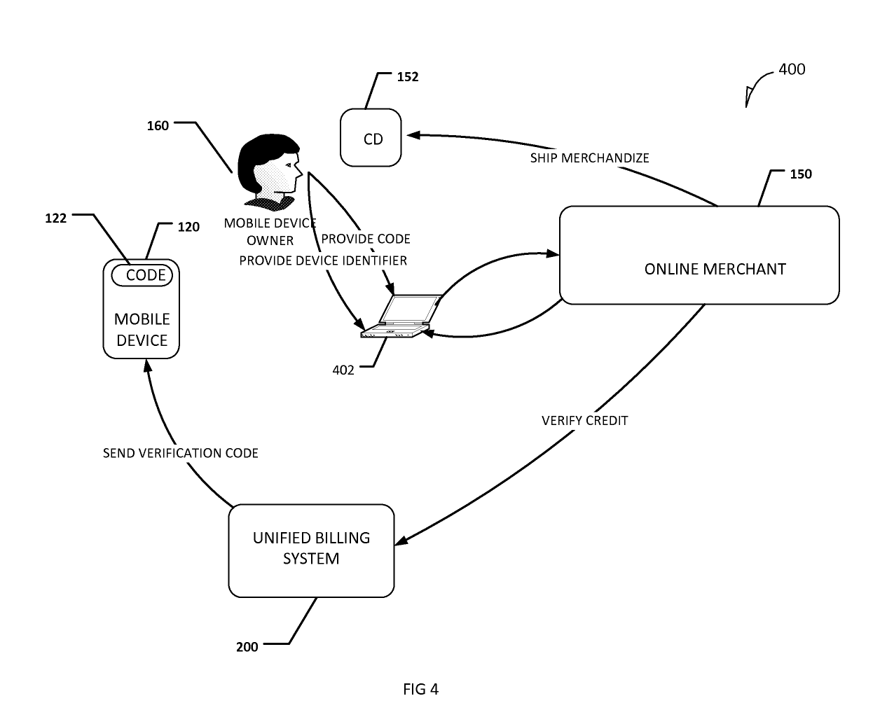

FIG. 4 is a block diagram showing an online merchant environment 400 utilizing a unified billing system, in accordance with an example embodiment. In one example embodiment, the mobile device owner 160 may wish to purchase a musical recording Compact Disk (CD) 152 through the online merchant 150 using the mobile device 120 utilizing the unified billing system 200. The mobile device owner 160 may use an internet capable device 402 to purchase the CD 152. When the mobile device owner 160 visits the online store using the internet capable device 402, he only needs to provide his mobile phone number, an intangible piece of information which is known to him, and a number associated with his mobile device 120, as a method of payment.

If the online merchant 150 participates in the unified billing system 200, it can send a request to process the transaction to the unified billing system 200. In an example, the mobile device owner 160 can have his credit request sent the unified billing system 200 for his creditworthiness to be verified, and when verified, the unified billing system 200 can send the code 122 to the mobile device 120. The mobile device owner 160 can then receive an SMS with the code 122 and the amount of the merchandise. The mobile device owner 160 can then provide the online merchant 150 with the code 122 as a method of payment. The CD 152 is then sent out and delivered by mail. Then the mobile device owner 160 can then provide the code 122 to the online merchant 150. The amount of this payment along with other payments and normal telephone charges can be billed to the mobile device owner 160 at the end of the month.

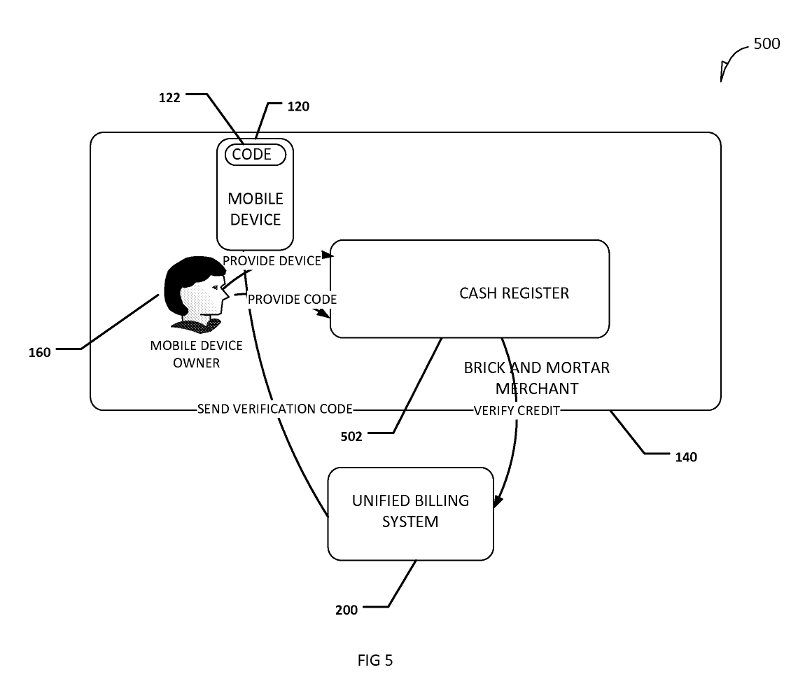

FIG. 5 is a block diagram showing a brick and mortar merchant environment 500 utilizing the unified billing system 200 in accordance with an example embodiment. When the mobile device owner 160 goes to the brick and mortar merchant (e.g. supermarket), he need only take his mobile device 120 with him as a method of payment. According to the example embodiment, the mobile device owner 160 can be purche groceries through the brick and mortar merchant 140 wherein the transaction takes place at a cash register 502 using the mobile device 120, utilizing the unified billing system provider 110 utilizing the unified billing system 200. When the mobile device owner 160 brings his selections to the cash register 502, the cashier asks him for his mobile number. The mobile device owner 160 can have his payment request sent to the unified billing system 200 for his creditworthiness to be verified, and when verified, the mobile device owner 160 can receive an SMS with the code 122 and the amount of the goods. He provides the merchant with the code 122 and after checkout, departs the store with his purchases. The billing is unified with other normal telephone charges such as the mobile device owner 160 calls another person, whereby he can be charged for the duration of the call and in turn have the amount for the call also charged by the unified billing system 200.

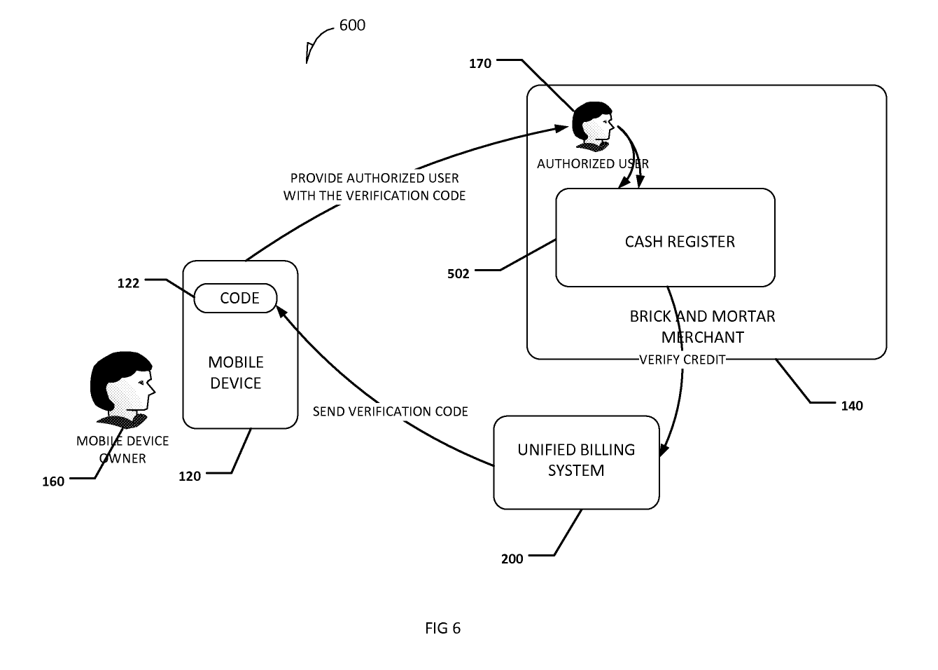

FIG. 6 is a block diagram showing a brick and mortar transaction environment 600 utilizing the unified billing system 200 in accordance with an example embodiment. According to the example embodiment, the mobiled device owner 160 may authorize the authorized user (e.g., his family member) to make purchases using the unified billing system 200. The authorized user 170 can make a purchase without being in possession of the mobile device 120. When the authorized user 170 makes a purchase, he or she can provide identifying information associated with the mobile device 120 (e.g., telephone number). A one time security coes (the code 122) can be sent to the mobile deivce 120 which can in be in possession of the mobile device owner 160 who reads the code and relays the code to the authorized user 170 (e.g., by calling the authorized user 170). Thereafter, the authorized user 170 can provide the code 122 to the brick and mortar merchant 140. The mobile device owner 160 can receive one bill with all the items he and other authorized people have purchased.

When the mobile device owner 160 pays the bill, all of the companies or other entities involved demanding payment, receive their respective payments. The unified billing system provider 110 may then assess a fee from each of the merchants that use the unified billing system 200 such as the online merchant 150, the brick and mortar merchant 140, and the government organization 130.

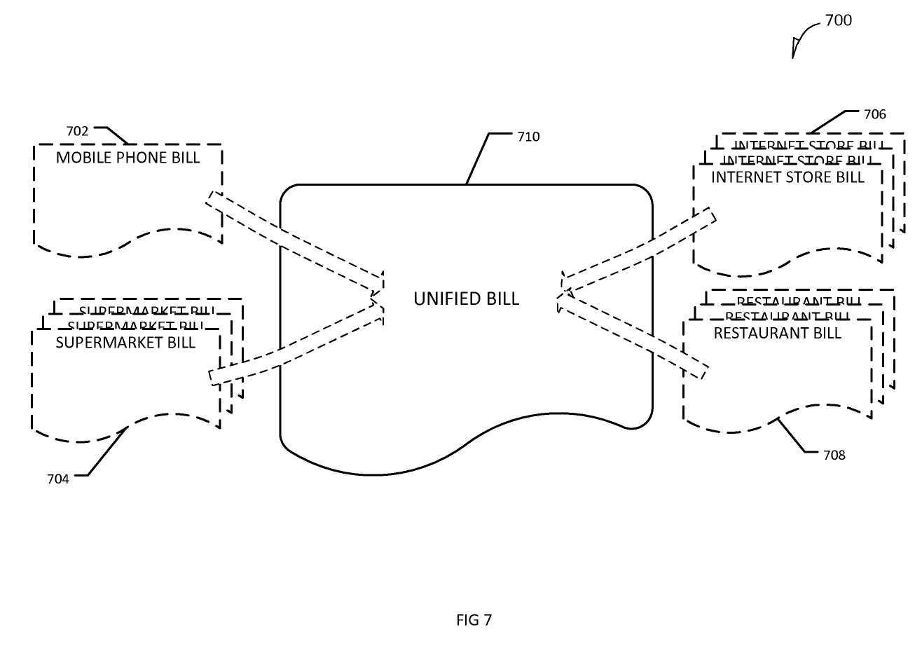

FIG. 7 is a block diagram showing a unified bill 710, in accordance with an example embodiment. As shown in FIG. 7, the unified bill 710 can include a mobile phone bill 702, a supermarket bill 704, an internet store bill 706, and a restaurant bill 708.

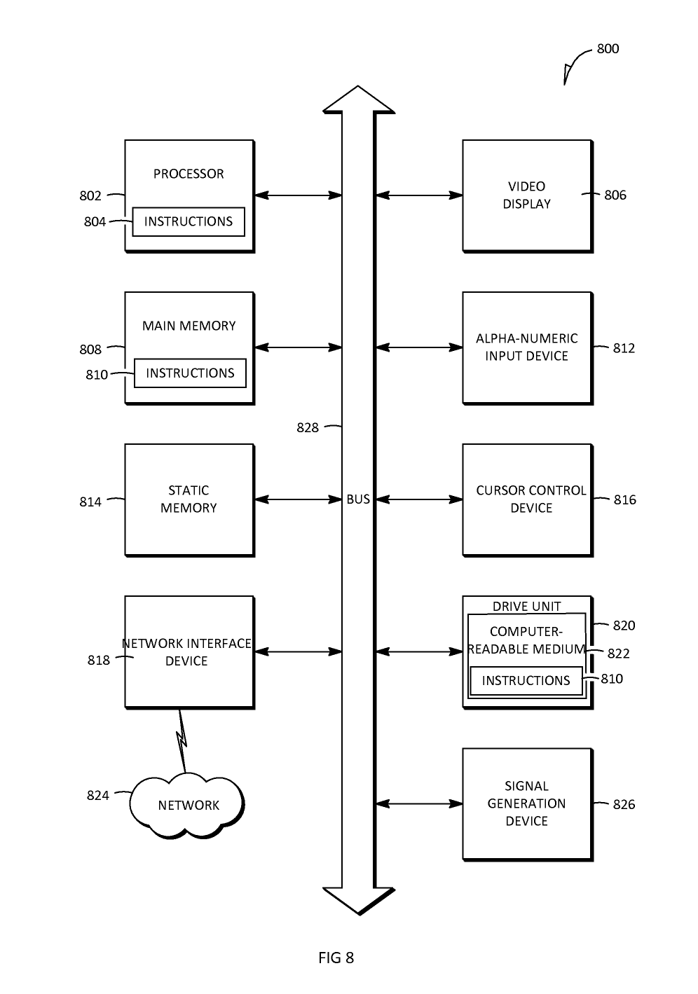

FIG. 8 is a diagrammatic representation of an example machine in the form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), and a main memory 808 and static memory 814, which communicate with each other via a bus 828. The computer system 800 may further include a video display unit 806 (e.g., a liquid crystal display (LCD)). The computer system 800 may also include an alphanumeric input device 812 (e.g., a keyboard), a cursor control device 816 (e.g., a mouse), a voice recognition or biometric verification unit, a disk drive unit 820, a signal generation device 826 (e.g., a speaker) and a network interface device 818. The computer system 800 may further include a data encryption module (not shown) to encrypt data.

The disk drive unit 820 includes a computer-readable medium 822 on which is stored one or more sets of instructions and data structures (e.g., instructions 810) embodying or utilizing any one or more of the methodologies or functions described herein. The instructions 810 may also reside, completely or at least partially, within the main memory 808 and/or within the processors 802 during execution thereof by the computer system 800. The main memory 808 and the processors 802 may also constitute machine-readable media.

The instructions 810 may further be transmitted or received over a network 824 via the network interface device 818 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, systems and methods for unified billing have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What I claim is:

1. A computer-implemented method for unified billing, the method comprising:
receiving, from a merchant, a request to process a transaction, the request including data related to a subscriber identity module (SIM);
based on the data, identifying a customer associated with the subscriber identity module (SIM);
ascertaining information related to a credit account associated with the customer;
based on the information, selectively sending a security code to the subscriber identity module (SIM), the security code to be provided to the merchant in order to complete the transaction;
receiving the security code from the merchant;
verifying the security code; and
based on the security code verification, selectively completing the transaction.

2. The computer-implemented method of claim 1, further comprising receiving from the customer, a request to create the credit account, the request including predetermined customer data to determine a creditworthiness of the customer and based on the customer data provide the credit account and associating the subscriber identity module with the credit account.

3. The computer-implemented method of claim 1, further comprising providing the subscriber identity module (SIM) to the customer.

4. The computer-implemented method of claim 1, further comprising periodically providing a bill to the customer associated with the credit account.

5. The computer-implemented method of claim 4, further comprising deducting an amount associated with the bill from a credit card or a debit card associated with the credit account.

6. The computer-implemented method of claim 5, further comprising providing the credit or the debit card associated with the credit account.

7. The computer-implemented method of claim 5, further comprising paying one or more merchants associated with the bill.

8. The computer-implemented method of claim 4, wherein the verification code is provided to the merchant by an authorized user having no possession of the subscriber identity module (SIM), the authorized user having received the verification code from the customer.

9. The computer-implemented method of claim 1, further comprising providing a telephone number associated with the subscriber identity module.

10. A system for unified billing, the method comprising:
a communication module to receive, from a merchant, a request to process a transaction, the request including data related to a subscriber identity module;
a customer identification module to identify, based on the data, a customer associated with the subscriber identity module (SIM);
a credit verification module to ascertain information related to a credit account associated with the customer;
a code generating module to selectively generate a security code to be sent to the subscriber identity module (SIM), the security code to be provided to the merchant in order to complete the transaction;
a code verification module to receive and verify the security code sent by the merchant; and
a transaction module to selectively complete the transaction based on the security code verification.

11. The system of claim 10, further comprising a credit request accepting module to receive from the customer, a request to create the credit account, the request including predetermined customer data to determine a creditworthiness of the customer and a credit issuing module to provide the credit account and associate the subscriber identity module with the credit account based on the customer data.

12. The system of claim 10, further comprising a subscriber identity module (SIM) provider to provide the subscriber identity module (SIM) to the customer.

13. The system of claim 12, wherein the subscriber identity module (SIM) provider provides a telephone number associated with the subscriber identity module (SIM).

14. The system of claim 10, further comprising a billing module to periodically provide a bill to the customer associated with the credit account.

15. The system of claim 14, wherein the billing module deducts an amount associated with the bill from a credit card or a debit card associated with the credit account.

16. The system of claim 14, further comprising a payment module to pay one or more merchants associated with the bill.

17. The system of claim 16, further comprising a credit-issuing module to provide the credit or the debit card associated with the credit account.

18. The system of claim 10, wherein the verification code is provided to the merchant by an authorized user having no possession of the subscriber identity module (SIM), the authorized user having received the verification code from the customer.

19. A machine-readable medium comprising instructions for unified billing, which when implemented by one or more processors, performs the following operations:
receive, from a merchant, a request to process a transaction, the request including data related to a subscriber identity module (SIM);
identify, based on the data, a customer associated with the subscriber identity module (SIM);
ascertain information related to a credit account associated with the customer;
selectively sending a security code to the subscriber identity module (SIM) based on the information, the security code to be provided to the merchant in order to complete the transaction;
receive the security code from the merchant;
verify the security code; and
based on the security code verification, selectively complete the transaction.
